(19) United States
(12) Patent Application Publication
(10) Pub. No.: US 2025/0272448 A1
(43) Pub. Date: Aug. 28, 2025

(54) METHOD FOR SYNCHRONIZED SOFTWARE-IN-THE-LOOP (SIL) SIMULATION OF MULTI-COMPONENT SIMULATION MODELS

(71) Applicant: dSPACE GmbH, Paderborn (DE)

(72) Inventors: Martin RÜHL, Paderborn (DE); Martin AUST, Paderborn (DE); Matthias DETER, Paderborn (DE); Tobias WITTELER, Paderborn (DE)

(21) Appl. No.: 19/059,382

(22) Filed: Feb. 21, 2025

(30) Foreign Application Priority Data
Feb. 22, 2024 (DE) 102024104989.8

(51) Int. Cl. G06F 30/15

(52) U.S. Cl. CPC G06F 30/15

(57) ABSTRACT

A method for synchronized software-in-the-loop (SIL) simulation includes: loading a first simulation component onto a computing farm with at least one computing module and a second simulation component onto an accelerator farm with at least one accelerator module, wherein the first simulation component is provided for a computer module, wherein the second simulation component is provided for an accelerator module; specifying a time master that triggers an execution of the first simulation component and the second simulation component, wherein a trigger initiates the execution of a simulation step comprising a time step of the first simulation component and a plurality of time steps of the second simulation component; and performing the synchronized SIL simulation by repeatedly triggering simulation steps, wherein a respective new simulation step is triggered upon the first and second simulation components having finished calculations of a respective current simulation step.

### CROSS-REFERENCE TO PRIOR APPLICATIONS

This application claims benefit to German Patent Application No. DE 102024104989.8, filed on Feb. 22, 2024, which is hereby incorporated by reference herein.

### FIELD

The invention relates to a method for synchronized software-in-the-loop (SIL) simulation of multi-component simulation models, wherein in particular a first simulation component is provided for execution on a processor and a second simulation component is provided for execution in a programmable logic module.

### BACKGROUND

Multi-component simulation models are used, for example, in the context of a hardware-in-the-loop simulation (HIL simulation), in which control units, in particular control units for motor vehicles, are tested for correct functioning. For this purpose, the control unit to be tested is connected to an electronic circuit, also known as an I/O circuit, with input and/or output channels in order to apply signals to the control unit via the circuit and/or to record signals generated by it. The signals to be output by the I/O circuit are determined by running the software model of a test environment on a simulation environment, for example the simulation of a journey in a motor vehicle. This allows a control unit to be operated in a simulated environment as if it were actually operating in the real environment.

The simulation environment, or simulator for short, is formed by a real-time computer system with at least one processor which processes the software model. For example, the model can be provided by real-time capable software or a plurality of interacting software tools, which preferably has a graphical user interface and is particularly preferably programmed using software objects. The software may include MATLAB, Simulink or RTI (Real-Time Interface) of the applicant, which forms a link to Simulink, for example. In the aforementioned cases, software objects are programmed graphically as blocks, for example, especially hierarchically. However, a simulation environment is not limited to the use of the software mentioned as examples. The software model can be run on the simulation environment either directly after programming or after code generation and compilation.

A real-time computer system differs from commercially available computer systems in particular in that a predetermined latency is not exceeded, for example between the input of a changed control signal and the resulting reaction, such as the output of a changed sensor signal. Depending on the system to be simulated, a maximum latency of, in particular, 1 millisecond or less may be required.

For example, a simulation of the drive of an electric vehicle (e-drive) or a simulation of power electronics places high demands on the speed of the control loop, especially with maximum permissible latencies in the range of individual microseconds, so that real-time simulations are often no longer covered by pure processor models and processor-controlled I/O channels, but the time-critical model parts are executed on a freely programmable logic module. The freely programmable logic module can in particular be a field programmable gate array (FPGA), which preferably has dedicated input and output channels. Typically, the time-critical component of the simulation model is implemented in a configuration for the programmable logic module. During initialization, the logic elements of the FPGA are interconnected using the configuration bit stream to execute the desired functionality, and the FPGA is configured to exchange data with the processor component of the simulation model, which is executed on the processor of the real-time computer system.

An HIL simulation requires the availability of at least one prototype control unit and can therefore only be used in a late development phase. In order to find errors in the control unit software as early as possible, software-in-the-loop tests (SIL tests) are increasingly being used. For example, dSPACE offers a PC-based simulation platform called VEOS for validating software in electronic control units (ECUs) that supports SIL tests and SIL simulations. VEOS enables the simulation of a wide variety of models, including functional models, functional mock-up units (FMUs), virtual control units (V-ECUs) and vehicle models, independent of any simulation hardware in early stages of development. In multi-model scenarios, the import, connection and execution of any number of function and plant models based on Simulink or Functional Mock-up Interface (FMI) are supported.

These PC-based SIL simulations are performed offline. This means that no connection to the actual target hardware is required, but the simulation is executed on a processing unit or computer. Depending on the processor of the computer that calculates the simulation and depending on the data available from the simulation participants, different challenges and approaches arise. In particular, a simulation component of a simulation model intended for execution on FPGA cannot yet be used in a SIL simulation. A processor-based emulation of a configuration bit stream is several orders of magnitude slower than the programmable logic module itself. Furthermore, the SIL simulation is not time-synchronous, but event-based or takes place in a virtual time domain. This makes the calculation time of simulation steps dynamic; the simulation can be faster or significantly slower than real time, and in particular can also vary during runtime, which makes coupling with real FPGA hardware for acceleration difficult. Due to this circumstance, a high-performance SIL simulation of electric machines is conventionally not possible. As a result, the application of FPGA models in a SIL simulation is conventionally not usable in practice.

### SUMMARY

In an exemplary embodiment, the present invention provides a method for synchronized software-in-the-loop (SIL) simulation. The method includes: loading a first simulation component onto a computing farm with at least one computing module and a second simulation component onto an accelerator farm with at least one accelerator module, wherein the first simulation component is provided for a computer module, wherein the second simulation component is provided for an accelerator module, wherein the first simulation component is assigned a first simulation step size, wherein the second simulation component is assigned a second simulation step size shorter than the first simulation step size; specifying a time master that triggers an execution of the first simulation component and the second simulation component, wherein a trigger initiates the execution of a simulation step comprising a time step of the first simulation component and a plurality of time steps of the second simulation component; and performing the synchronized SIL simulation by repeatedly triggering simulation steps, wherein a respective new simulation step is triggered upon the first and second simulation components having finished calculations of a respective current simulation step.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows an exemplary view of an HIL simulator executing a first sub-model on a processor and a second sub-model on an FPGA;

FIG. 2 shows a schematic representation of a multi-rate simulation on a HIL simulator; and

FIG. 3 shows a schematic representation of a multi-rate simulation in the SIL case.

### DETAILED DESCRIPTION

Exemplary embodiments of the invention provide a method and a device which enable a software-in-the-loop simulation of combined simulation models with processor and FPGA components.

In an exemplary embodiment, the invention provides a method for synchronized SIL simulation of a simulation model with a first simulation component, which is provided for a computer module, and a second simulation component, which is provided for an accelerator module and by a computer system.

A method is provided for the synchronized SIL simulation of a first simulation component, which is provided for a computer module, and a second simulation component, which is provided for an accelerator module. The first component is assigned a first simulation step size, and the second component is assigned a second simulation step size, in particular a shorter one. The method comprises the steps of:
loading the first simulation component onto a computing farm with at least one computing module and the second simulation component onto an accelerator farm with at least one accelerator module,
specifying a time master that triggers an execution of the first simulation component and the second simulation component, wherein a trigger initiates the execution of a simulation step comprising a time step of the first simulation component and a plurality n of time steps of the second simulation component,
performing the simulation by repeatedly triggering a simulation step, wherein a new simulation step is triggered as soon as the first and second simulation components have finished the calculations of the current simulation step.

The invention has the advantage that a consistent workflow is possible in which simulation models can be transferred 1:1 from HIL to SIL. An existing SIL toolchain can be extended to be used with existing platform-specifically distributed multi-rate applications.

In a preferred embodiment of the invention, the computer module is a processor, whereas the accelerator module is a programmable logic module and the second component is implemented as a configuration bit stream. This embodiment is particularly suitable for the simulation of electrical machines or drives and/or power electronics.

In a preferred embodiment of the invention, the programmable logic module has a clock-enable input, via which at least one part of the programmable logic module implementing the second component is stopped as soon as the desired number of clock cycles for the simulation step has been executed. Therefore, if there are variations in the calculation time of simulation steps in the virtual time domain of the SIL simulation, the waiting time for which at least part of the programmable logic module is stopped can be extended accordingly.

In embodiments of the invention, the computing module is a processor of a first instruction architecture, while the accelerator module comprises at least one computing core with support of parallel processing and/or at least one computing core for matrix calculations and/or a processor with a second instruction architecture which differs from the first instruction architecture. The method for synchronized SIL simulation of a first and a second simulation component is applicable to various heterogeneous hardware platforms.

Expediently, the plurality n of time steps of the second simulation component are determined from the ratio of a time step of the first simulation component to a time step of the second simulation component. In particular, the time steps that apply to a HIL simulation are considered. This is advantageous because the time step of the first simulation component in the HIL system corresponds to a real time, whereas in the case of a SIL simulation a discontinuous virtual time is used.

In a preferred embodiment of the invention, the plurality n of time steps of the second simulation component are calculated synchronously to a fixed clock cycle of the accelerator module.

In one embodiment of the invention, a separate process on the processor executing the first component is specified as the time master.

The invention further relates to a computer system comprising a computing farm with at least one processor, in particular a plurality of processors, an accelerator farm with at least one programmable logic module, in particular a plurality of programmable logic modules. Instructions for carrying out a method according to the invention are stored in a non-volatile memory of the computer system.

Furthermore, the invention relates to a non-volatile data carrier with a computer-readable storage medium on which commands are embedded that, if executed by a processor, cause the processor to be configured to execute a method according to the invention.

The invention is explained in more detail below with reference to the drawings. In doing so, similar parts are labeled with identical designations. The embodiments shown are strongly schematized; that is, the distances and the lateral and vertical dimensions are not to scale and, unless otherwise indicated, do not have any derivable geometric relations relative to each other.

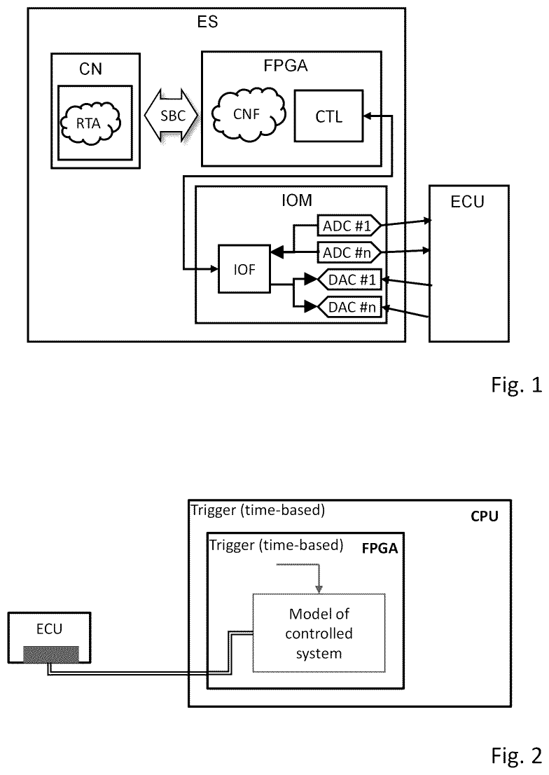

FIG. 1 shows schematically an exemplary HIL simulator ES and a control unit ECU to be tested.

The real-time capable HIL simulator ES comprises a computing node CN, which comprises at least one processor CPU. A logic board with a programmable logic module FPGA and two I/O circuits ADC, DAC is connected to the computing node via a high-speed bus SBC. It can also be provided that the simulator ES has several logic boards or several programmable logic modules FPGA on one logic board. The logic board preferably has one or more slots for I/O modules. Shown is an I/O module IOM, which is connected to the control unit ECU to be tested and can, for example, exchange digital input and output signals with it. The I/O circuit ADC has one or more analog-to-digital converters that receive analog signals from the control unit DUT under test. Via the I/O circuit DAC, which has one or more digital-analog converters, the simulator ES can output analog signals to the control unit ECU to be tested.

Freely programmable logic modules FPGA are used in particular for fields of application such as e-drive and power electronics, because particularly fast control loops occur there. Logic boards with such an FPGA conveniently have several slots for I/O modules; for example, dSPACE offers the DS6601 FPGA Base Board with five slots that can be equipped with different I/O modules. An existing test environment can be expanded by installing a new I/O module, for example to include analog-to-digital conversion with a high resolution.

The HIL simulator runs a simulation model with two components. A first sub-model RTA or a first simulation component is stored on the computing node CN and is executed as a real-time application by the processor of the computing node. The programmable logic module FPGA is configured in such a way that a second sub-model CNF or a second simulation component is implemented on one part of the surface and a control module CTL is implemented on another part of the surface. The control module CTL is connected via module IOF to an I/O module IOM, which has analog-digital converters ADC #1, ADC #n and digital-analog converters DAC #1 and DAC #n.

FIG. 2 shows a schematic representation of an existing solution for mapping multi-rate applications in the HIL context. FPGA technology is used as a computing accelerator to stably map specific model parts in the simulation according to their dynamics. A typical field of application is e-mobility, with examples being the simulation and control of electric motors. However, applications from the ADAS/AD domain are also relevant, where GPUs are often used as fast computing nodes. In the HIL use case, FPGAs typically sample a factor of ˜100,000 faster than CPUs, and are strictly time-synchronized (step size of CPU models typically 1 ms-100 μs; FPGA clock cycle typically 8 ns).

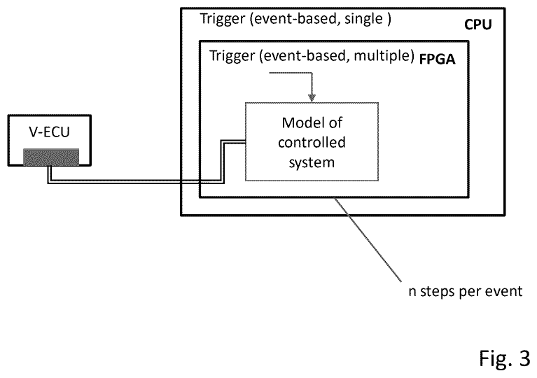

FIG. 3 shows a schematic representation of an embodiment according to the invention for mapping multi-rate applications in a SIL simulation.

The embodiment provides that—as in the HIL approach—a CPU (or several CPUs) communicate with one (or more) fast real-time nodes—e.g., FPGA resources—within the framework of a co-simulation. In the co-simulation, the overall system represents mathematical models of real physical systems as a multi-rate system, for example the control of an electric motor in a vehicle, which is implemented with 10 kHz, for example.

Preferably, in the SIL case, especially on the CPU side, a purely virtual time is used, which is usually discontinuous with respect to real time. The synchronization described in this application is distinguished by the fact that it synchronizes the number of calculated steps on all participating calculation nodes, which is independent of the computing frequencies of the participating computing resources (e.g., FPGAs).

When discretely mapping multi-rate models in the SIL environment, the requirement for synchronicity is no longer in the time domain, but in the correct processing sequence of the calculation steps to ensure consistent calculation results.

In order to achieve synchronization between the calculation nodes (e.g., CPU(s) and FPGA(s)), the presumably slowest participant of the networked co-simulation preferably takes on the role of the master. After a calculation step by the master, the associated faster simulation participants (slaves) are requested by the master to carry out the n simulation steps corresponding to the multi-rate ratio “as soon as possible.” Alternatively, the master can also be determined explicitly; an external master can also trigger the execution of all simulation components involved. As part of debugging, the automatically repeated triggering can be stopped and the execution can be carried out in a targeted, manually triggered “single-step procedure.”

For calculation synchronization, the—as fast as possible—clock frequency of the actually installed fast target platform(s) (e.g., FPGA or GPU) is triggered by the task manager. As soon as the number of necessary calculation steps of the slave(s) has been completed, the task manager calls the master again and the cycle starts again.

For each calculation step, a number of FPGA clock cycles must be executed, determined from the ratio of the CPU model step size to the FPGA clock rate; in an alternative embodiment, the requirement for clock-accurate execution is replaced by a time measurement with a specified accuracy, such as 50 ns.

In the typical application, only a small amount of data is exchanged between the processor and the FPGA; for example, the processor specifies a desired setpoint for the controlled variable (e.g., torque, speed), and the detailed control takes place in the FPGA.

The calculation steps can be triggered by a separate process as master, which is either executed on the processor that also executes the CPU model; alternatively, a separate processor can execute the trigger process.

For example, the FPGA can be stopped using the clock-enable input as soon as the desired number of clock cycles for the computing step have been processed. It is not necessary here to stop the entire FPGA; rather, it may be sufficient to stop the sub-region that implements the simulation component.

There is typically at least one configurable clock generator on FPGAs or FPGA boards that can be used to implement the invention. In one embodiment, a controller for time synchronization or clock control can be implemented on a sub-region of the FPGA.

With this invention, it is possible for the first time to use the FPGA technology used in HIL for the software-in-the-loop (SIL) world. The SIL world is distinguished by the fact that the models used (or the code generated from them) are executed independently of the real time, sometimes faster than real time, sometimes slower than real time, sometimes in step-by-step mode, depending on the needs of the specific test case. Previously, this was only possible with CPU code-based components. The invention disclosure now extends the “SIL methodology” to other code/calculation methods (e.g., FPGAs or GPUs) that have so far only been used in the “real-time world.” This makes it possible for the first time to transfer FPGA models for controlling electric motors 1:1 into the SIL world and to reuse the same models (or the FPGA code generated from them) and the corresponding HIL tests. In SIL testing, however, there is also the option of slowing down the calculation of the entire system as required. In addition, the overall models can now be executed in parallel relatively easily—e.g., in a cloud environment—in order to run as many tests as possible as quickly as possible.

It will be appreciated from the foregoing description that a model may include at least a first simulation component (CPU-Model) and a second simulation component (FPGA-model) that are to be synchronized, and that exemplary embodiments of the present invention provide a system having a computing farm with one or more processors, wherein a task manager assigns different processes/tasks to a processor and is responsible for scheduling the processes/tasks. In an implementation, the task manager may also trigger execution of the model components (as an external master). Alternatively, the first component (as presumably the slowest participant) can be designated as master and trigger execution of the second component on the FPGA (which is then slave). In another embodiment, there may be a negotiation mechanism for determining whether the first or the second component is the master (or whether an external master is to be used).

It will further be appreciated from the foregoing description that a time master triggers calculations for a simulation step, and the time master may be, for example, a process executed on a processor of the computing farm (in which case the computing farm may implement both the first simulation component and the task manager). The time master may also be, for example, a controller implemented on a sub-region of a programmable logic module of the accelerator farm. The time master may also be, for example, a process executed on a computing core of the accelerator farm (in which case the accelerator farm may implement both the second simulation component and the task manager).

It will further be appreciated from the foregoing description that both the computing farm and the accelerator farm may be implemented as hardware. For example, the computing farm may be implemented as a rack of a plurality of processors, and the accelerator farm may be implemented as a rack of programmable logic modules or computing cores/processors. The computing farm may run system software for operating the processors and for managing the different software processes, including the task manager. The task manager provides a schedule of when to execute a process/task on a processor and distributes the different processes on different processors for execution. The task manager may be, for example, part of the infrastructure provided by a cloud service provider. The programmable logic modules of the accelerator farm, for example, are configured for specific functionality by loading a bitstream that defines the logic functions to be performed (e.g., similar to designing/defining an electronic circuit). In an implementation, the accelerator farm may comprise a plurality of computing cores (such as GPUs) that execute software, and the software may be managed by the task manager running on the computing farm.

It will further be appreciated from the foregoing description that the time master may be implemented as hardware or software. The time master may be specified, for example, based on reading in software programs, setting files, and/or configuration bitstreams. The time master may be designated when setting up the computer system for the simulation, and the simulation component with the longest time between simulation steps (i.e., the slowest simulation component) may be designated as the time master. The time master may also be designated as an external master. In the case of an accelerator farm comprising programmable logic modules, the time master may, for example, be designated as a controller implemented on an FPGA. In the case of an accelerator farm comprising computing cores/processors, the time master may, for example, be designated as a simulation component executed on a computing core/processor.

It will further be appreciated from the foregoing description that different parts of the computer system may be involved in performing the synchronized SIL simulation. For example, when the first simulation component is executed for one simulation step, the second simulation component is also activated for a corresponding number of clock cycles (or, in the case of software for a corresponding number of time steps for that component). Synchronicity is ensured via the time master triggering the next simulation step.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for synchronized software-in-the-loop (SIL) simulation, comprising:
loading a first simulation component onto a computing farm with at least one computing module and a second simulation component onto an accelerator farm with at least one accelerator module, wherein the first simulation component is provided for a computer module, wherein the second simulation component is provided for an accelerator module, wherein the first simulation component is assigned a first simulation step size, wherein the second simulation component is assigned a second simulation step size shorter than the first simulation step size;
specifying a time master that triggers an execution of the first simulation component and the second simulation component, wherein a respective trigger initiates the execution of a respective simulation step comprising a time step of the first simulation component and a plurality of time steps of the second simulation component; and
performing the synchronized SIL simulation by repeatedly triggering simulation steps, wherein a respective new simulation step is triggered upon the first and second simulation components having finished calculations of a respective current simulation step.

2. The method according to claim 1, wherein the computer module is a processor, wherein the accelerator module is a programmable logic module, and wherein the second simulation component is implemented as a configuration bit stream.

3. The method according to claim 2, wherein the programmable logic module has a clock-enable input and at least a part of the programmable logic module implementing the second simulation component is stopped via the clock-enable input upon a desired number of clock cycles for the simulation step having been executed.

4. The method according to claim 1, wherein the computing module is a processor of a first instruction architecture; and
wherein the accelerator module comprises:
at least one computing core with parallel processing support;
at least one computing core for matrix calculations; and/or
a processor with a second instruction architecture which differs from the first instruction architecture.

5. The method according to claim 1, wherein the plurality of time steps of the second simulation component are determined from a ratio of a time step of the first simulation component to a time step of the second simulation component.

6. The method according to claim 5, wherein the time step of the first simulation component in a hardware-in-the-loop (HIL) system corresponds to a real time; and
wherein a discontinuous virtual time is used for an SIL simulation.

7. The method according to claim 1, wherein a majority of the plurality of time steps of the second simulation component are calculated synchronously to a fixed clock cycle of the accelerator module.

8. The method according to claim 1, wherein a separate process on a processor executing the first component is specified as the time master.

9. A computer system, comprising:
a computing farm with at least one processor; and
an accelerator farm with at least one programmable logic module;
wherein the computing farm is configured to load a first simulation component;
wherein the accelerator farm is configured to load a second simulation component;
wherein the first simulation component is provided for a computer module, wherein the second simulation component is provided for an accelerator module, wherein the first simulation component is assigned a first simulation step size, wherein the second simulation component is assigned a second simulation step size shorter than the first simulation step size;
wherein the system further comprises a time master specified for the system, wherein the time master is configured to trigger an execution of the first simulation component and the second simulation component, wherein a respective trigger initiates the execution of a respective simulation step comprising a time step of the first simulation component and a plurality of time steps of the second simulation component; and
wherein the computing farm and the accelerator farm are configured to perform the synchronized SIL simulation based on repeated triggering of simulation steps, wherein a respective new simulation step is triggered upon the first and second simulation components having finished calculations of a respective current simulation step.

10. A non-transitory computer-readable medium having processor-executable instructions for synchronized software-in-the-loop (SIL) simulation, wherein the processor-executable instructions, when executed, facilitate performance of the following:
loading a first simulation component onto a computing farm with at least one computing module and a second simulation component onto an accelerator farm with at least one accelerator module, wherein the first simulation component is provided for a computer module, wherein the second simulation component is provided for an accelerator module, wherein the first simulation component is assigned a first simulation step size, wherein the second simulation component is assigned a second simulation step size shorter than the first simulation step size;
specifying a time master that triggers an execution of the first simulation component and the second simulation component, wherein a respective trigger initiates the execution of a respective simulation step comprising a time step of the first simulation component and a plurality of time steps of the second simulation component; and
performing the synchronized SIL simulation by repeatedly triggering simulation steps, wherein a respective new simulation step is triggered upon the first and second simulation components having finished calculations of a respective current simulation step.
